(19) United States
(12) Patent Application Publication
(10) Pub. No.: US 2026/0225903 A1
(43) Pub. Date: Aug. 6, 2026

(54) SUPPORTED ABSORBENTS FOR AMMONIA SEPARATION

(71) Applicant: Texas Tech University System, Lubbock, TX (US)

(72) Inventors: Mohammadmahdi Malmali, Lubbock, TX (US); S M Tanveer Mahtab, Lubbock, TX (US)

(21) Appl. No.: 18/877,870

(22) PCT Filed: Jun. 23, 2023
(86) PCT No.: PCT/US2023/026133

§ 371 Date: Dec. 20, 2024

Related U.S. Application Data
(60) Provisional application No. 63/354,955, filed on Jun. 23, 2022.

(51) Int. Cl. C01C 1/04; B01D 53/04; B01D 53/047; B01J 20/04; B01J 20/28; B01J 20/32

(52) U.S. Cl. CPC C01C 1/0458; B01D 53/0423; B01J 20/046; B01J 20/28052; B01J 20/3204; B01J 20/3236; B01D 53/047; B01D 2253/112; B01D 2253/25; B01D 2257/102; B01D 2257/108

(57) ABSTRACT

A system and method of producing ammonia comprises reacting a nitrogen feed gas and a hydrogen feed gas in a reactor to form ammonia, wherein the reaction produces a reaction mixture comprising ammonia gas, unreacted nitrogen and unreacted hydrogen, absorbing the ammonia from the reaction mixture in an absorber column containing an absorber, the absorber comprising a support and a metal halide, outputting the ammonia absorbed by the absorber, and recycling the unreacted nitrogen and unreacted hydrogen.

### CROSS REFERENCE TO RELATED PATENT APPLICATIONS

This application claims the priority and benefit under 35 U.S.C. § 119(e) of U.S. Provisional Patent Application Ser. No. 63/354,955 filed Jun. 23, 2023, entitled “SUPPORTED ABSORBENTS FOR AMMONIA SEPARATION.” U.S. Provisional Patent Application Ser. No. 63/354,955 is herein incorporated by reference in its entirety.

### TECHNICAL FIELD

Embodiments are generally related to the field of chemical synthesis. Embodiments are further related to energy production and storage. Embodiments are also related to ammonia production.

### BACKGROUND

Ammonia is one of the world's most important chemicals. In addition to its use as a synthetic fertilizer, ammonia can also be used as an efficient means for energy storage. Manufacturing ammonia has remained surprisingly unchanged for over a century.

The most common process for ammonia production is known as the Haber-Bosch process. The Haber-Bosch process involves using high pressures and temperatures in large, capital-intensive plants, where nitrogen and hydrogen gas are combined over a catalyst. Ongoing developments and modifications of the Haber-Bosch process have been introduced in an effort to improve the overall efficiency. However, there remain significant inefficiencies in the Haber-Bosch process.

For example, one major drawback of the Haber-Bosch process is use of phase-changing separation for product removal from the recycled gas. Phase-changing separations are energy-intensive. The cost of separation is inversely proportional to the concentration of the desired product, which makes high pressure and high temperature in the synthesis loop a must, because higher partial pressure of ammonia is in favor of the separation. Hence, for cost-effective condensation, a higher reaction pressure is required to increase the partial pressure of ammonia in the reactor exhaust. However, higher pressure processing requires higher capital and operating costs.

In the conventional reaction-condensation process, the gas mixture that leaves the reactor at ~450° C. needs to be cooled down to −20° C. to separate ammonia, which requires significant heat exchange.

Metal halide absorbents are promising candidates for selective separation of ammonia. These materials have excellent thermodynamic capacity for ammonia, even at temperatures as high as 300° C. The major challenge with using metal halides for separation of ammonia is their instability. It has been demonstrated that supporting metal halides on silica using wet impregnation results in more stable structures, with improved absorption performance. In wet impregnation, a large volume of dilute salt solution (typically 20-50 times larger than the volume of the support) is required, and the support will be immersed in the solution. The solvent (water or an organic solvent) will be evaporated, and salt will dry partially inside and mostly outside the support. Drying will continue until a paste is formed. The sample will be then calcined in a furnace.

A notable challenge with wet impregnation methods is that the salts are not fully impregnated within the pores of the inert support. Instead, metal halide salts are mostly agglomerated and dispersed over the surface of the support. In addition, after repeated cycles the absorbent will detach from the surface of the support (a phenomenon known as attrition). The detached absorbents will then phase segregate and will be collected at the bottom of the absorber column. When ammonia is being introduced to the column after multiple absorption-desorption cycles, the absorbents collected at the bottom will expand upon up taking ammonia, and therefore the pressure drop in the absorber column increases significantly. Due to the expansion of the salts, the metal halide absorbents fuse and form relatively larger particles, hence absorption will become kinetically limited by diffusion of the ammonia within larger metal halide solid. Further, at least a 10-20% decline in capacity results in the cyclic operation because ammonia cannot be desorbed quickly from large particles. Finally, wet impregnation is not favorable for production at scale since a large volume of solvents (typically organic) should be evaporated during the synthesis. It requires time and energy consuming drying which can result in degradation of the metal halides. Overall, wet impregnation is not very efficient, as the majority of the salt remains on the surface of the support and not encaged within the pores.

Given the increasing demand for ammonia, particularly for use in energy storage applications, there is a need for improved systems and methods for efficient production of ammonia as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide chemical synthesis.

It is another aspect of the disclosed embodiments to provide methods and systems for ammonia production.

It is another aspect of the disclosed embodiments to provide systems and apparatuses for chemical production.

It is another aspect of the disclosed embodiments to provide methods, systems, and apparatuses comprising supported absorbents for ammonia separation and energy storage.

It will be appreciated that the methods and systems can be achieved according to the embodiments disclosed herein. For example, the disclosed embodiments, comprise a novel method to stabilize metal halides for ammonia separation and storage. Metal halides can be supported on mesoporous and macroporous supports using dry impregnation. Supported absorbents developed using this method are more mechanically and chemically stable, display improved kinetics for uptake and release ammonia, and are well suited for scale up. The salts are more precisely encaged with the pores of the support, which makes them more stable. Compared to wet impregnation, the disclosed method here is technically simpler, cheaper to operate, and produces less amount of waste during the synthesis.

In an embodiment, a system for ammonia production comprises a feed preparation stage for preparing feed gasses, a synthesis loop wherein the feed gasses are reacted to produce ammonia, and a separation stage for separating excess feed gasses from the produced ammonia, the separation stage further comprising an absorber column and a regenerator column.

In an embodiment, the system for ammonia production further comprises an absorber configured to selectively absorb ammonia in order to separate ammonia from other particles, the absorber comprising at least one metal halide and a solid support. In an embodiment, the metal halide comprises magnesium chloride. In an embodiment the solid support comprises mesoporous silica (SBA-15). In an embodiment, the absorber is synthesized via dry impregnation. In an embodiment, the volume of the metal halide is nominally half the volume of the support.

In an embodiment, the separation stage further comprises at least three absorber columns. In an embodiment, the system for ammonia production further comprises conduit for directing the produced ammonia and excess feed gasses from the synthesis loop to the absorber column during a desorption wherein excess heat is transferred to the absorber column. In an embodiment, the feed preparation stage comprises a pressure swing absorption system for producing nitrogen and an electrolysis system for producing hydrogen.

In another embodiment, a method of producing ammonia comprises reacting a nitrogen feed gas and a hydrogen feed gas in a reactor to form ammonia, wherein the reaction produces a reaction mixture comprising ammonia gas, unreacted nitrogen, and unreacted hydrogen, absorbing the ammonia from the reaction mixture in an absorber column containing an absorber, the absorber comprising a support and a metal halide, outputting the ammonia absorbed by the absorber, and recycling the unreacted nitrogen and unreacted hydrogen. In an embodiment, the method of producing ammonia further comprises synthesizing the absorber via dry impregnation. In an embodiment, the method of producing ammonia further comprises creating a solution of the metal halide and adding the solution to the support. In an embodiment, the solution comprises a solution of magnesium chloride. In an embodiment, the support comprises mesoporous silica (SBA-15). In an embodiment, the volume of the solution is nominally half the volume of the support. In an embodiment, the method of producing ammonia further comprises providing heat from the reactor to the absorber column.

In another embodiment, a system for producing ammonia comprises a nitrogen gas feed, a hydrogen gas feed, a reactor configured to facilitate a reaction of the nitrogen gas feed and the hydrogen gas feed wherein the reaction produces a reaction mixture comprising ammonia gas, unreacted nitrogen gas and unreacted hydrogen gas, an absorber column containing an absorber configured for absorbing the ammonia gas from the reaction mixture, a separation system comprising at least one absorber column and a regenerator column configured to further separate ammonia from the reaction mixture, wherein at least some of the reaction mixture is used to heat the separation system. In an embodiment, the absorber comprises a metal halide and a solid support synthesized via dry impregnation. In an embodiment, the metal halide comprises magnesium chloride and the solid support comprises mesoporous silica (SBA-15).

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a system for producing ammonia, in accordance with the disclosed embodiments;

FIG. 2 depicts aspects of a system for producing ammonia, in accordance with the disclosed embodiments;

FIG. 3 depicts a diagram of a system for producing ammonia, in accordance with the disclosed embodiments;

FIG. 4 depicts a process for producing ammonia, in accordance with the disclosed embodiments;

FIG. 5 depicts a method for synthesizing an absorber, in accordance with the disclosed embodiments;

FIG. 6 depicts the performance of the wet impregnated MgCl₂ on silica during the long-time stability tests, in accordance with the disclosed embodiments;

FIG. 7 depicts a chart relating to Wl—Si—CaCl₂, in accordance with the disclosed embodiments;

FIG. 8 depicts images of SBA-15, in accordance with the disclosed embodiments;

FIG. 9 depicts the microscopic images of the dry impregnated MgCl₂ on SBA-15, in accordance with the disclosed embodiments;

FIG. 10 depicts the nitrogen isotherms of the dry impregnated MgCl₂ on SBA-15, in accordance with the disclosed embodiments;
FIG. 11 depicts the nitrogen isotherms of the wet impregnated MgCl₂ on silica, in accordance with the disclosed embodiments;
FIG. 12 depicts an image of SBA-15, in accordance with the disclosed embodiments;
FIG. 13 depicts a chart of intensity as a function of angle, in accordance with the disclosed embodiments;
FIG. 14 illustrates additional images of SBA-15, in accordance with the disclosed embodiments;
FIG. 15 provides a chart illustrating the capacity of the support material as a function of temperature, in accordance with the disclosed embodiments; and
FIG. 16 illustrates a chart showing an absorbed quantity as a function of relative pressure, in accordance with the disclosed embodiments.

### DETAILED DESCRIPTION

Embodiments and aspects of the disclosed technology are presented herein. The particular embodiments and configurations discussed in the following non-limiting examples can be varied, and are provided to illustrate one or more embodiments, and are not intended to limit the scope thereof.

Reference to the accompanying drawings, in which illustrative embodiments are shown are provided herein. The embodiments disclosed can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

This disclosed embodiments are directed to a high-temperature reaction-absorption process for enhanced ammonia synthesis at low pressure. In the disclosed embodiments, an absorber column is employed, which can further comprise a packed bed of cheap, abundant metal halide salts, including but not limited to supported MgCl₂ and CaCl₂, that can operate at between 25-330° C. Ammonia produced in the Haber-Bosch reactor can be separated using an absorber column. This separation unit allows lower pressure operation while separating ammonia more completely from the reactor outlet gas mixture.

In further embodiments, a novel method to stabilize metal halides for ammonia separation and storage is disclosed. Metal halides can be supported on mesoporous and macroporous supports using dry impregnation.

According to the disclosed embodiments, absorbents can be used to separate ammonia from the hot gas mixture leaving the Haber-Bosch reactor. The disclosed embodiments are further drawn to a method for synthesizing supported metal halides via dry impregnation (as opposed to wet impregnation). In this method, a concentrated metal halide solution can be prepared. The amount of solution being added to the porous support can be equal to the pore volume of the support (usually half the volume of the support). In this method, the metal halide solution will be immediately sucked into the porous support due to the capillary effect. After impregnation, the final product is still in powdered form, and no post-drying is required to evaporate the solvent outside the support that might otherwise result in degradation of the metal halides. The disclosed method for impregnation is beneficial as the salts will be more completely encased in the pores of the inert mesoporous and macroporous support, including but not limited to mesoporous silica (SBA-15), microporous silica, macroporous silica (MCM), etc.

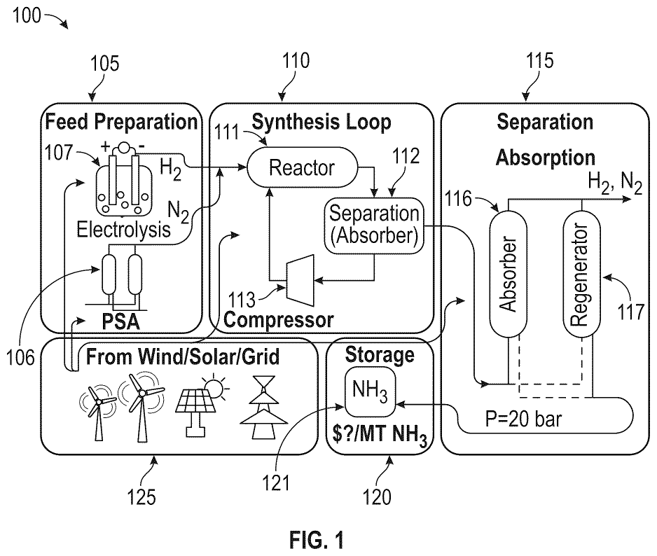

FIG. 1 illustrates a system 100 for ammonia synthesis in accordance with the disclosed embodiments. System 100 generally includes a feed preparation stage 105, a synthesis loop 110, a separation stage 115, and a storage component 120. The system further requires energy input 125.

In the feed preparation stage 105 nitrogen gas and hydrogen gas can be produced. In an exemplary embodiment, nitrogen gas can be produced via pressure swing absorption 106 and hydrogen gas can be produced via electrolysis 107. Both these processes require energy which can be provided via energy input 125. It should be noted PSA and electrolysis are exemplary means of acquiring nitrogen gas and hydrogen gas respectively, but, in other embodiments, other methods of acquiring these gasses can be used.

Next in the synthesis loop the nitrogen gas and hydrogen gas can be fed to a reactor 111 where ammonia is synthesized. The reactor can outflow gas, which includes the produced ammonia and any unreacted nitrogen gas or hydrogen gas to a separation absorber column 112. The separation absorber column 112 serves to separate the ammonia, which is provided to the separation stage 115, and the left over nitrogen or hydrogen, which can be compressed with compressor 113 and recycled back into the reactor 111.

The output from the separation absorber column can comprise a mixture of ammonia as well as some unreacted nitrogen gas or hydrogen gas. The output gas can be provided to absorber columns 116 or 117 in the separation stage 115. These two absorber columns operate in cyclic fashion, with one being in the absorption mode (separating ammonia from the reactor output) while the other is in the regeneration mode (releasing the separated ammonia during the absorption). The remaining hydrogen and nitrogen gas can be recycled back to the synthesis loop, while the released ammonia can be stored in pressurized storage 121 of storage component 120 (e.g., a tank). The stored ammonia is thus ready for use.

It should be noted that the feed preparation stage, synthesis loop, and separation stage all require energy which can preferably be provided by wind, solar, or power grid power supplies.

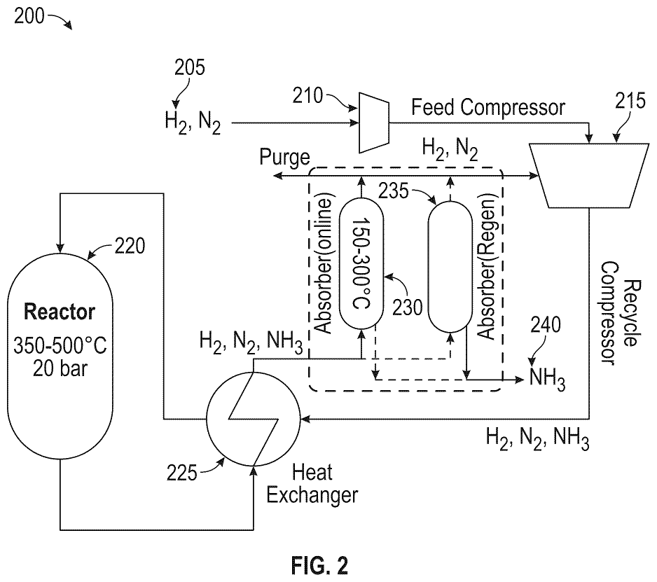

FIG. 2 illustrates aspects of an ammonia synthesis system 200 in accordance with the disclosed embodiments. In this embodiment, a feed stock of nitrogen and hydrogen gas 205 can be provided to the feed compressor 210. The compressed gas is then fed through a recycle compressor 215 which adds recycled hydrogen and nitrogen gas to the recycled gas feed.

The gas feed is provided to the reactor 220 via a heat exchanger 225. The reactor 220 can operate at 20 bar of pressure and a temperature of 350-500° C. The output from the reactor can comprise unused nitrogen gas, unused hydrogen gas, and ammonia. The gas flow is cooled through heat exchanger 225, and then sent to an online absorber column 230, which can separate the ammonia from any unused gasses. The absorber column 230 disclosed herein, replace a standard condensation system. Heat from the reactor effluent is transferred to the regenerating column 235 to release the ammonia. The separated ammonia 240 can be output for storage, while any remaining nitrogen or hydrogen gas can be recycled into the recycle compressor 215, for use in a subsequent product cycle.

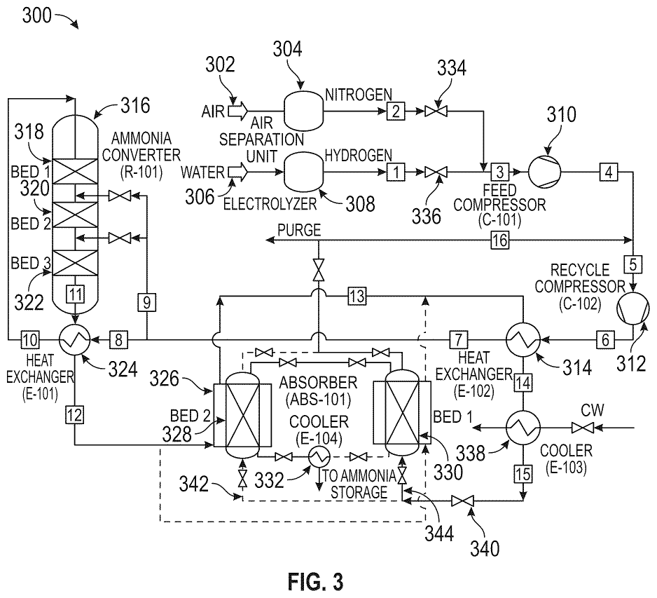

FIG. 3 illustrates a more detailed system diagram for an ammonia separation system 300 in accordance with the disclosed embodiments. It should be appreciated that certain aspects of the systems disclosed in FIGS. 1-3 may be functionally equivalent or identical in some cases. It should be noted that the system 300 provides heat integration, where the converter effluent is first directed to one of the absorber column shell sides in the desorption mode, through which the released reaction heat is transferred to the absorber column to regenerate the absorbents.

An air feed 302 can be provided to an air separation unit 304 to separate nitrogen gas. Likewise, a water feed 306 can be provided to an electrolyzer 308 to produce hydrogen gas. Gas feeds of nitrogen and hydrogen can be controlled by valves 334 and 336 respectively. The nitrogen gas feed and hydrogen gas feed can be mixed and compressed with a feed compressor 310. The compressed gas mixture can then be routed through a recycle compressor 312 along with unreacted nitrogen or hydrogen gas from a previous cycle, to heat exchanger 314.

Output from the heat exchanger 314 can be provided to ammonia converter 316. The ammonia converter 316 can include three beds, bed 318, bed 320, and bed 322. The ammonia converter converts the hydrogen gas and nitrogen gas, with aid of a catalyst, into ammonia.

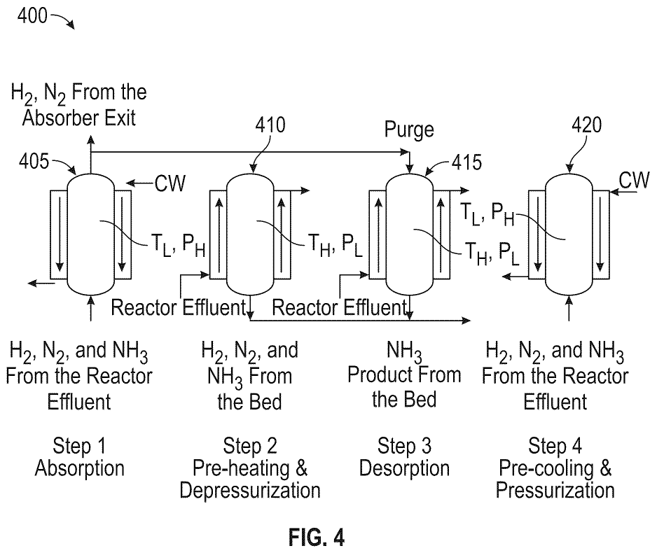

The ammonia converter can discharge the ammonia through heat exchanger 324, along with unreacted nitrogen gas and hydrogen gas. This gas flow can be provided to an absorber column 326 which can include a first bed 328 and a second bed 330. The absorber 326 can be cooled with cooled water from cooler 338, the flow of which can be controlled by master valve 340, first bed valve 342 and second bed valve 344. The absorber column can be packed with an absorber as further detailed herein. The absorber 326 serves as part of a regenerating loop for ammonia production as detailed in FIG. 4. Output from the absorber column 326 can include ammonia and non-product gasses including hydrogen gas and nitrogen gas. The product ammonia can be provided to a cooler 332 and then output to ammonia storage. The non-product gas can be purged, and any remaining hydrogen gas or nitrogen gas can be provided back to the recycle compressor 312 for use in additional product cycles.

FIG. 4 is a schematic diagram 400 of the pressure-swing adsorption (PSA)/temperature-swing adsorption (TSA) processes for continuous operation of the absorber columns in accordance with the disclosed embodiments. It should be noted that the schematic illustrates three absorbers for the cyclic PSA/TSA operation, but in other embodiments additional absorber columns can be used.

As illustrated in FIG. 4, step 1 is absorption. In this step, hydrogen gas, nitrogen gas and ammonia from the reactor effluent are provided to absorber column 405. Cooling water can be circulated to maintain the absorber 405 at low temperature but at high pressure. The absorber separates ammonia from the hydrogen gas and nitrogen gas, which can be recycled or provided the absorber 415 at step 3.

Step 2 involves preheating and depressurizing absorber 410 with the reactor effluent. In this stage reactor effluent is provided to absorber 410 to heat the absorber while lowering the pressure.

Step 3 is the desorption step. In this step, reactor effluent is provided to the absorber 415 which is at high temperature and low pressure. The absorber 415 outputs concentrated ammonia from the bed. After completion of the desorption, precooling and pressurization 420 can begin, as shown at Step 4, in preparation for the next cycle in the continuous operation of the absorber.

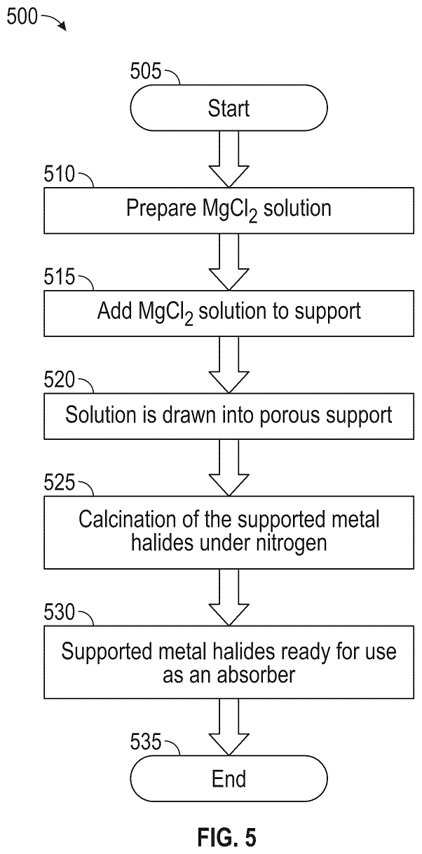

An aspect of the disclosed embodiments is the use of an absorber comprising supported metal halides synthesized via dry impregnation. FIG. 5 illustrates a method for synthesizing supported metal halides. The method begins at 505.

At step 510 a concentrated MgCl₂ solution will be prepared. Next the metal halide solution (e.g., MgCl₂) can be added to the dried support at step 515. In certain embodiments the support can comprise mesoporous silica (SBA-15). In certain embodiment the amount of MgCl₂ can be equal to the pore volume of the support. In most cases this will be half the volume of the support, but other volumes are possible. At step 520 the solution will be drawn into the porous support pores due to the capillary effect. It should be noted that the impregnated absorber is still in powder form. The supported metal halides can now be calcined at, for example, 500° C. in nitrogen at step 525. The dried supported metal halides can now be used as an absorber as shown at step 530, for example, in the production of ammonia as detailed herein. The method ends at 535.

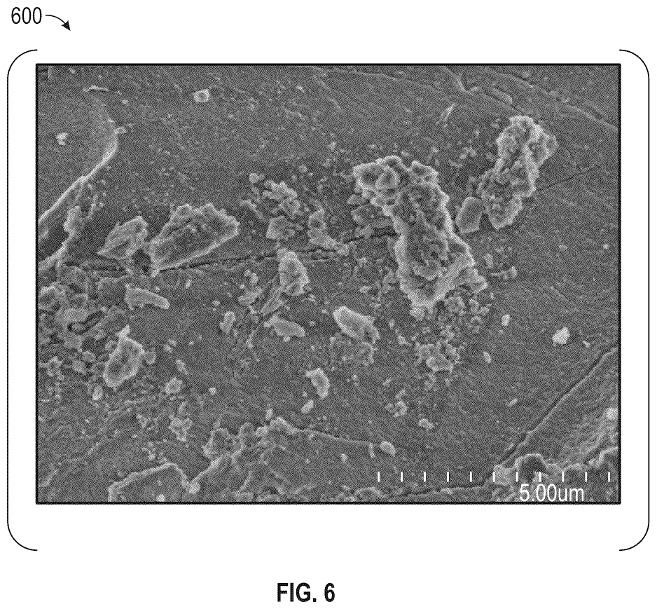

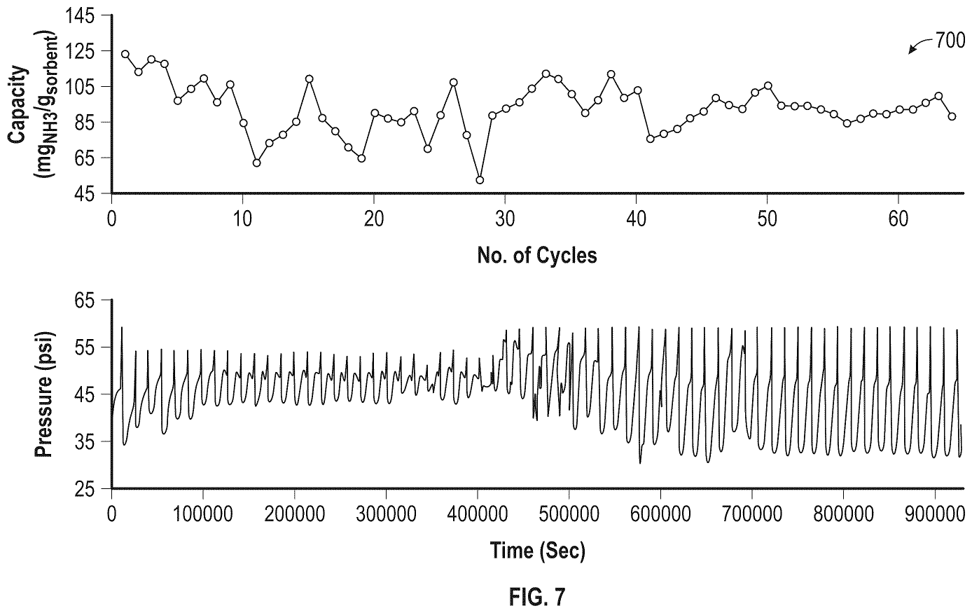

Wet impregnation of MgCl₂ displays the highest working capacity of 275 mg_{NH3}/g_{sorbent} (at 25 C and 0.5 bar partial pressure of ammonia). However, this type of impregnation does not lead to complete encaging of the metal halide salt particles. As displayed in the image 600 in FIG. 6, a large portion of the MgCl₂ is freely standing outside of the pores and on the surface of the silica. The salts can detach from the surface through long-term cyclic absorption-regeneration cycles and lead to instability in the performance of the absorber, as illustrated in chart 700 in FIG. 7. As shown, the pressure of the absorber starts to fluctuate significantly during the breakthrough tests after 30 cycles. The capacity also declines by roughly 40-50%.

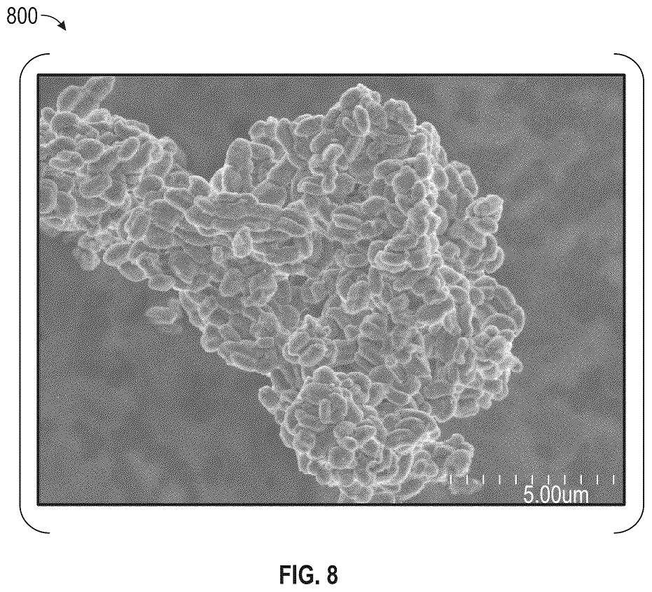

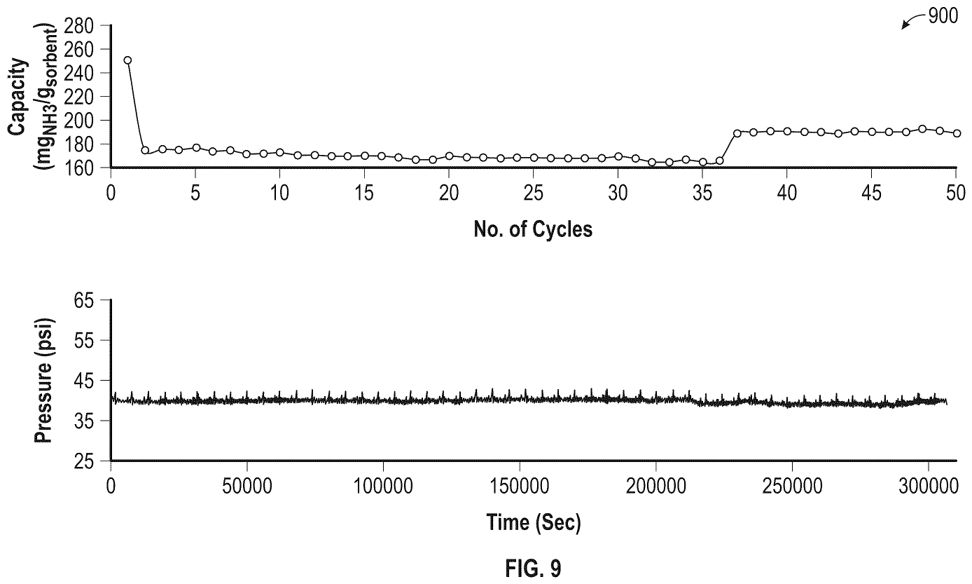

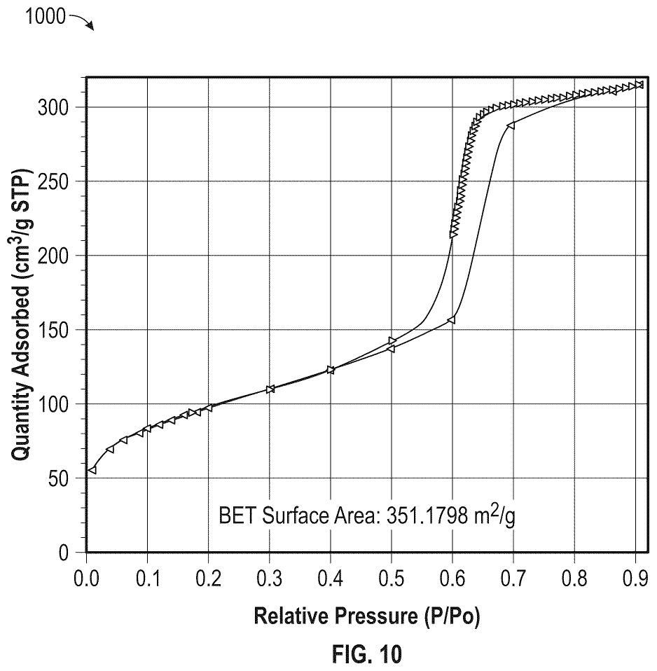

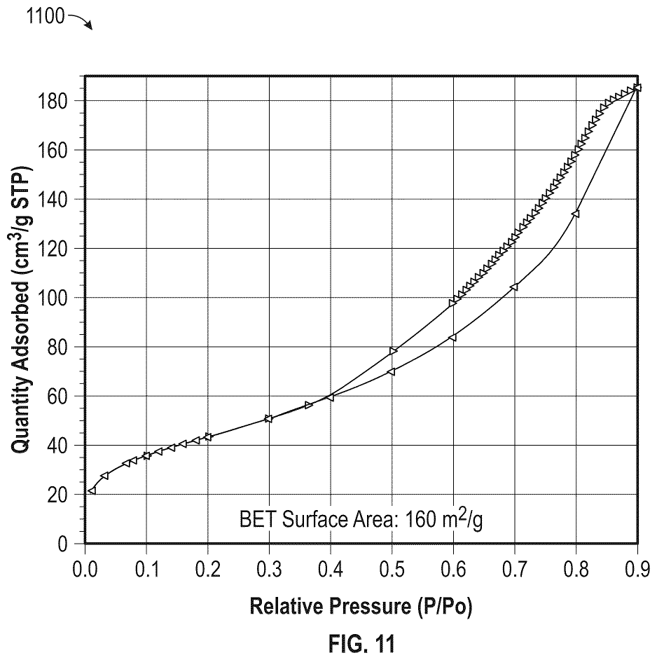

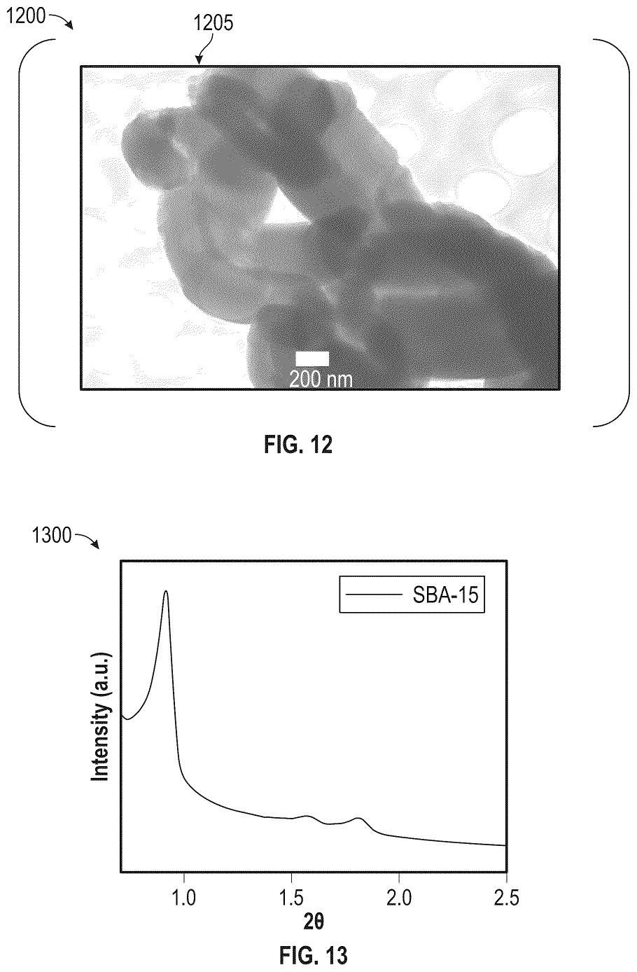

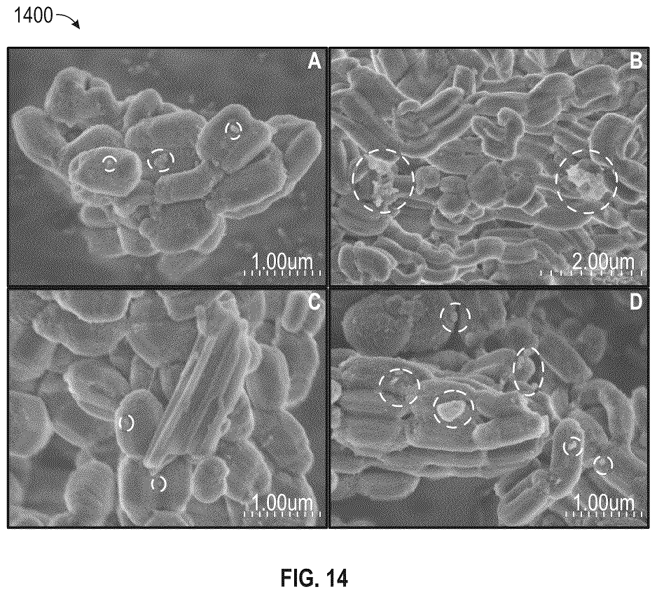

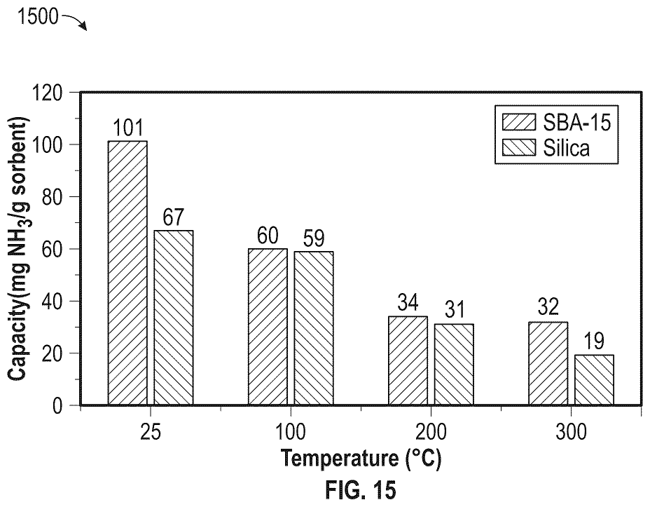

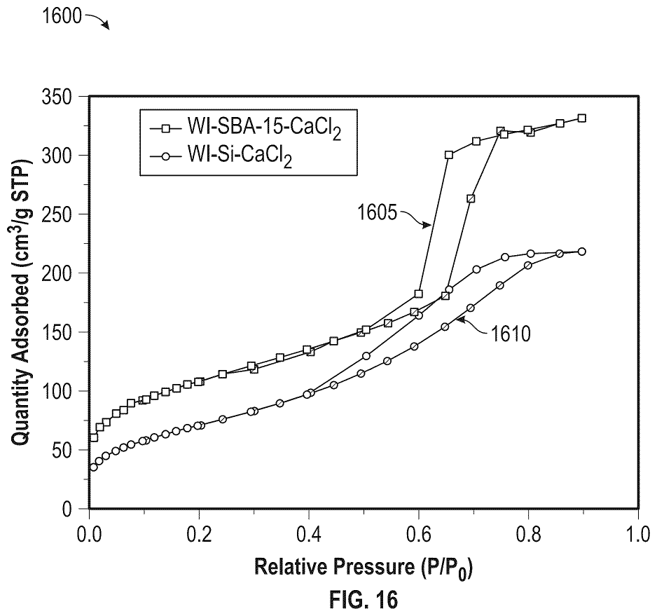

It should be appreciated that the disclosed supported absorbents can uptake and release ammonia with excellent kinetic rates, and with a competitive working capacity (working capacity can be defined as the reproducible capacity of the absorbent after +100 cycles). Dry impregnation of MgCl₂ displays a competitive working capacity of 225 mg_{NH3}/g_{sorbent} (at 25 C and 0.5 bar partial pressure of ammonia). The metal halide salts are completely impregnated into the mesopores and macropores of the support, as depicted in the image 800 of SBA-15 in FIG. 8. Therefore, absorbent performance does not decline due to the attrition and detachment of the metal halides through absorption-regeneration cycles as displayed in chart 900 in FIG. 9. As a result, when the synthesized absorber is used in an absorber column, pressure drop, as compared to previous methods, will be reduced as the metal halides are more effectively encased in the support. Additionally, the comparison of nitrogen absorbents suggest that the dry impregnated MgCl₂ displayed BET areas 372 m²/g_{sorbent} (as illustrated by chart 1000 in FIG. 10), while wet impregnated MgCl₂ displayed BET areas 161 m²/g_{sorbent} (as illustrated by chart 1100 in FIG. 11). Furthermore, the disclosed methods are environmentally and energetically more amenable for scale up as it obviates the need for evaporating large volumes of organic solvents.

Besides ammonia separation in the Haber-Bosch process, metal halides can be utilized for seasonal thermochemical energy storage, as they have an extraordinary capacity for ammonia storage.

FIG. 12 illustrates a transmission electron microscope image 1200 of a support 1205 comprising SBA-15. The image 1200 illustrates the hexagonal pore morphology of SBA-15. FIG. 13 shows a chart 1300 of SBA-15 intensity as a function of angle. The chart illustrates the small angle x-ray diffraction of the SBA-15 support. The chart further shows that SBA-15 has high crystallinity, with a well-ordered porous structure.

FIG. 14 illustrates additional images 1400 of SBA-15 in accordance with the disclosed embodiments. FIG. 15 provides a chart 1500 illustrating the capacity of the support material as a function of temperature in accordance with the disclosed embodiments. FIG. 16 illustrates a chart 1600 showing an absorbed quantity as a function of relative pressure for Wl-SBA-15-CaCl₂ 1605, and Wl—Si—CaCl₂ 1610.

Based on the foregoing, it can be appreciated that a number of embodiments, preferred and alternative, are disclosed herein. In an embodiment, a system for ammonia production comprises a feed preparation stage for preparing feed gasses, a synthesis loop wherein the feed gasses are reacted to produce ammonia, and a separation stage for separating excess feed gasses from the produced ammonia, the separation stage further comprising an absorber column and a regenerator column.

In an embodiment, the system for ammonia production further comprises an absorber configured to selectively absorb ammonia in order to separate ammonia from other particles, the absorber comprising at least one metal halide and a solid support. In an embodiment, the metal halide comprises magnesium chloride. In an embodiment the solid support comprises mesoporous silica (SBA-15). In an embodiment, the absorber is synthesized via dry impregnation. In an embodiment, the volume of the metal halide is nominally half the volume of the support.

In an embodiment, the separation stage further comprises at least three absorber columns. In an embodiment, the system for ammonia production further comprises conduit for directing the produced ammonia and excess feed gasses from the synthesis loop to the absorber column during a desorption wherein excess heat is transferred to the absorber column.

In an embodiment, the feed preparation stage comprises a pressure swing absorption system for producing nitrogen and an electrolysis system for producing hydrogen.

In another embodiment, a method of producing ammonia comprises reacting a nitrogen feed gas and a hydrogen feed gas in a reactor to form ammonia, wherein the reaction produces a reaction mixture comprising ammonia gas, unreacted nitrogen, and unreacted hydrogen, absorbing the ammonia from the reaction mixture in an absorber column containing an absorber, the absorber comprising a support and a metal halide, outputting the ammonia absorbed by the absorber, and recycling the unreacted nitrogen and unreacted hydrogen.

In an embodiment, the method of producing ammonia further comprises synthesizing the absorber via dry impregnation.

In an embodiment, the method of producing ammonia further comprises creating a solution of the metal halide and adding the solution to the support. In an embodiment, the solution comprises a solution of magnesium chloride. In an embodiment, the support comprises mesoporous silica (SBA-15). In an embodiment, the volume of the solution is nominally half the volume of the support.

In an embodiment, the method of producing ammonia further comprises providing heat from the reactor to the absorber column.

In another embodiment, a system for producing ammonia comprises a nitrogen gas feed, a hydrogen gas feed, a reactor configured to facilitate a reaction of the nitrogen gas feed and the hydrogen gas feed wherein the reaction produces a reaction mixture comprising ammonia gas, unreacted nitrogen gas and unreacted hydrogen gas, an absorber column containing an absorber configured for absorbing the ammonia gas from the reaction mixture, a separation system comprising at least one absorber column and a regenerator column configured to further separate ammonia from the reaction mixture, wherein at least some of the reaction mixture is used to heat the separation system. In an embodiment, the absorber comprises a metal halide and a solid support synthesized via dry impregnation. In an embodiment, the metal halide comprises magnesium chloride and the solid support comprises mesoporous silica (SBA-15).

It will be appreciated that variations of the above-disclosed and other features and functions, or alternatives thereof, may be desirably combined into many other different systems or applications. Also, it should be appreciated that various presently unforeseen or unanticipated alternatives, modifications, variations, or improvements therein may be subsequently made by those skilled in the art which are also intended to be encompassed by the following claims.

1. A system for ammonia production comprising:
a feed preparation stage for preparing feed gasses;
a synthesis loop wherein the feed gasses are reacted to produce ammonia; and
a separation stage for separating excess feed gasses from the produced ammonia, the separation stage further comprising an absorber column and a regenerator column.

2. The system for ammonia production of claim 1 further comprising:
an absorber configured to selectively absorb ammonia in order to separate ammonia from other particles, the absorber comprising at least one metal halide and a solid support.

3. The system for ammonia production of claim 2 wherein the metal halide comprises magnesium chloride.

4. The system for ammonia production of claim 2 wherein the solid support comprises mesoporous silica (SBA-15).

5. The system for ammonia production of claim 2 wherein the absorber is synthesized via dry impregnation.

6. The system for ammonia production of claim 2 wherein the volume of the metal halide is nominally half the volume of the support.

7. The system of claim 1 wherein the separation stage further comprises:
at least three absorber columns.

8. The system of claim 7 further comprising:
conduit for directing the produced ammonia and excess feed gasses from the synthesis loop to the absorber column during a desorption wherein excess heat is transferred to the absorber column.

9. The system of claim 1 wherein the feed preparation stage comprises:
a pressure swing absorption system for producing nitrogen; and
an electrolysis system for producing hydrogen.

10. A method of producing ammonia, the method comprising:
reacting a nitrogen feed gas and a hydrogen feed gas in a reactor to form ammonia, wherein the reaction produces a reaction mixture comprising ammonia gas, unreacted nitrogen, and unreacted hydrogen;
absorbing the ammonia from the reaction mixture in an absorber column containing an absorber, the absorber comprising a support and a metal halide;
outputting the ammonia absorbed by the absorber; and
recycling the unreacted nitrogen and unreacted hydrogen.

11. The method of producing ammonia of claim 10 further comprising:
synthesizing the absorber via dry impregnation.

12. The method of producing ammonia of claim 10 further comprising:
creating a solution of the metal halide; and
adding the solution to the support.

13. The method of producing ammonia of claim 10 wherein the solution comprises:
a solution of magnesium chloride.

14. The method of producing ammonia of claim 10 wherein the support comprises:
mesoporous silica (SBA-15).

15. The method of producing ammonia of claim 12 wherein the volume of the solution is nominally half the volume of the support.

16. The method of producing ammonia of claim 10 further comprising:
providing heat from the reactor to the absorber column.

17. A system for producing ammonia, the system comprising:
a nitrogen gas feed;
a hydrogen gas feed;
a reactor configured to facilitate a reaction of the nitrogen gas feed and the hydrogen gas feed wherein the reaction produces a reaction mixture comprising ammonia gas, unreacted nitrogen gas and unreacted hydrogen gas;
an absorber column containing an absorber configured for absorbing the ammonia gas from the reaction mixture;
a separation system comprising at least one absorber column and a regenerator column configured to further separate ammonia from the reaction mixture, wherein at least some of the reaction mixture is used to heat the separation system.

18. The system for producing ammonia of claim 17 wherein the absorber comprises a metal halide and a solid support synthesized via dry impregnation.

19. The system for producing ammonia of claim 18 wherein the metal halide comprises magnesium chloride and the solid support comprises mesoporous silica (SBA-15).
